(19) United States
(12) Patent Application Publication
(10) Pub. No.: US 2011/0161931 A1
(43) Pub. Date: Jun. 30, 2011

(54) AUTOMATED STREAM-BASED CHANGE FLOWS WITHIN A SOFTWARE CONFIGURATION MANAGEMENT SYSTEM

(75) Inventors: JOHN D. CAMELON, Ottawa (CA); GEOFFREY M. CLEMM, Lexington, MA (US); JIM J. DES RIVIERES, Ottawa (CA); JEAN-MICHEL LEMIEUX, Ottawa (CA); CAROL D. YUTKOWITZ, Lexington, MA (US)

(73) Assignee: INTERNATIONAL BUSINESS MACHINES CORPORATION, ARMONK, NY (US)

(21) Appl. No.: 12/650,808

(22) Filed: Dec. 31, 2009

(51) Int. Cl. G06F 9/44

(52) U.S. Cl. 717/121; 717/122

(57) ABSTRACT

Using stream-based change flow models to propagate source code file changes within a software configuration management system can begin with the detection of the addition of a source code file, either a new file or new version, to a software configuration management system by a change flow manager. The source code file can then be related to a component based upon the hierarchical placement of the source code file within the filesystem. Stream-based change flow models that contain the component can be identified. Change flow relationships within a stream-based change flow model can define the propagation of changes between streams (an aggregate of components) and/or components. Authorization from a human agent can be requested to initiate propagation of the source code file. Upon receipt of an affirmative response, the source code file can be automatically copied to the container objects that correspond to the identified recipients for changes.

### BACKGROUND

The present invention relates to the field of software configuration management systems and, more particularly, to automated stream-based change flows within a software configuration management system.

Software configuration management systems provide software developers with vital tools for storing the multitude of documents, particularly source code files, associated with the creation of software applications. Typically, a hierarchical tree of container objects or folders is used by the software configuration management system to organize groups of related documents. Each software application is represented by such a tree and any common source code files must be individually and manually copied between trees.

As with any manual process, errors are easily introduced. The tree structure simply provides a laundry list of files, devoid of any relationships or dependencies other than the parent-child relationship of the tree. Thus, the relationships between source code files used by multiple software applications must be documented and maintained separate from the software configuration management system. Lack of documentation and/or communication about such relationships often results in lost or reproduced work.

Further, as the library of source code files grows, with either new documents or new versions, finding the correct source code file within the software configuration management system becomes more difficult, making it easier for the incorrect source code file to be used in an application. While search functions can help, there are often multiple files having identical names, though stored in different tree structures. Additional time is lost to the developer in determining the correct file, if the path hierarchy of the file is not readily known.

### BRIEF SUMMARY

One aspect of the present invention can include an automated method for using stream-based change flow models to propagate source code file changes within a software configuration management system. The addition of a source code file, either a new file or new version, to a software configuration management system can be detected by a change flow manager. The source code file can then be related to a component based upon the hierarchical placement of the source code file within the filesystem of the software configuration management system. The identifier of the component can correspond to the identifier of a container object within the filesystem that denotes a primary subsystem of a software application. Stream-based change flow models that contain the component can be identified. The stream-based change flow model can define change flow relationships between a first stream containing the component and a second stream or a second component of the second stream that can be designated as the recipient for changes to the component. Further, a stream can abstractly represent an aggregate of components. Authorization from a human agent can be requested to initiate propagation of the source code file within the software configuration management system in accordance the stream-based change flow models. Upon receipt of an affirmative response, the source code file can be automatically copied into the container objects within the filesystem that correspond to the identified recipient for changes defined within the stream-based change flow models.

Another aspect of the present invention can include a software configuration management system that utilizes stream-based change flow models to automate the propagation of source code file changes. Such a task management system can include components, stream, stream-based change flow models, a change flow interface, and a change flow manager. Components can correspond to the container objects of source code files within the filesystem of the software configuration management system. These container objects can represent the primary subsystems of software applications stored within the software configuration management system. Streams can abstractly define aggregates of components. Stream-based change flow models can define change flow relationships between a first stream or component of the first stream and a second stream or a component of the second stream. The second stream or component of the second stream can be designated as the recipient for changes from the first stream or component of the first stream. The change flow interface can be configured to provide a graphical interaction mechanism for capturing, presenting, and performing operations upon the stream-based change flow models. The change flow manager can be configured to automate the propagation of changes to a source code file within the software configuration management system based upon relevant stream-based change flow models. The propagation of the source code file can require authorization from a human agent.

Yet another aspect of the present invention can include a computer program product that includes a computer readable storage medium having embedded computer usable program code. The computer usable program code can be configured to detect the addition of a source code file, a new file or new version, to a software configuration management system. The computer usable program code can be configured to relate the source code file to a component based upon the hierarchical placement of the source code file within the filesystem of the software configuration management system. The identifier of the component can correspond to the identifier of a container object within the filesystem that denotes a primary subsystem of a software application. The computer usable program code can then be configured to identify stream-based change flow models containing the component. The stream-based change flow model can define change flow relationships between a first stream containing the component and a second stream or a second component of the second stream that can be designated as the recipient for changes to the component. Further, a stream can abstractly represent an aggregate of components. Next, the computer usable program code can be configured to request authorization from a human agent to propagate the source code file within the software configuration management system according to the stream-based change flow models. Upon receipt of an affirmative response, the computer usable program code can be configured to automatically copy the source code file into the container objects within the filesystem that correspond to the identified recipients for changes defined within the stream-based change flow models.

### BRIEF DESCRIPTION OF THE SEVERAL VIEWS OF THE DRAWINGS

FIG. 1 is a schematic diagram illustrating a system that can automate the propagation of source code files within a software configuration management system using stream-based change flow models in accordance with embodiments of the inventive arrangements disclosed herein.

FIG. 2 is a collection of example representations of a software application project in accordance with an embodiment of the inventive arrangements disclosed herein.

FIG. 2A is an example scenario illustrating file changes within a software configuration management system when propagating a change through a stream-based change flow model.

FIG. 3 is a collection of additional example stream-based change flow models in accordance with an embodiment of the inventive arrangements disclosed herein.

FIG. 4 is a flow chart of a method detailing the automated propagation of new source code files using a stream-based change flow model in accordance with embodiments of the inventive arrangements disclosed herein.

### DETAILED DESCRIPTION

The present invention discloses a solution for utilizing stream-based change flow models to automate the propagation of source code file changes within a software configuration management system. A stream-based change flow model can define change flow relationships between one stream or component and another stream or component. Components can correlate to the container objects that represent the primary subsystems of software applications, while streams can represent aggregates of components. A change flow relationship can indicate how changes to the source code files of the stream or component should flow to the targeted stream or component. Based upon the change flow relationships captured in the stream-based change flow models, a change flow manager can automatically determine where to copy changes to a source code file within the software configuration management system.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing. Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

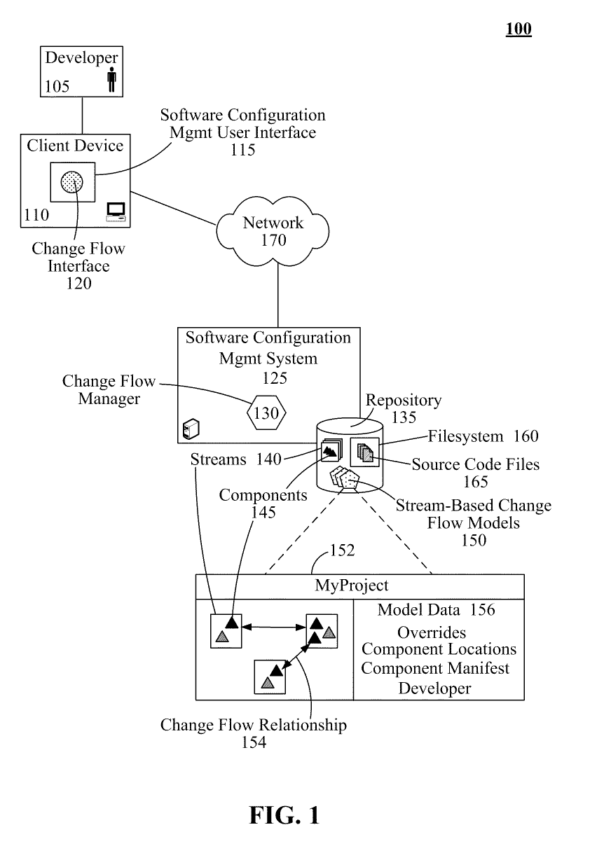

FIG. 1 is a schematic diagram illustrating a system 100 that can automate the propagation of source code files 165 within a software configuration management system 125 using stream-based change flow models 150 in accordance with embodiments of the inventive arrangements disclosed herein. In system 100, a developer 105 can utilize the change flow interface 120 presented within the user interface 115 of the software configuration management system 125 to define stream-based change flow models 150 and/or their elements 140 and 145.

The software configuration management system 125 can represent the hardware and/or software for a computing system designed to perform configuration management functions for source code files 165. Typical functions supported by a software configuration management systems 125 can include, but are not limited to, tracking file revisions, tracking revision changes, performing library functions (check-in/check-out), handling parallel file branches, storing files, and the like.

The software configuration management system 125 can include a repository 135 for storing the source code files 165. Further, the source code files 165 can be stored within the software configuration management system 125 according to predefined filesystem 160 such as the commonly used hierarchical tree structure. The filesystem 160, when viewed within the software configuration management user interface 115, can provide the developer 105 with a visual and logical organization of container objects (i.e., folders and projects) and source code files 165, masking the physical storage arrangement within the repository 135.

For example, a software application having four subsystems (i.e., GUI, messaging, etc.) can be represented as a project object with four subordinate folders, one for each subsystem. Each folder can then contain the source code files 165 that comprise the corresponding subsystem (e.g., the GUI folder contains source code files 165 that support the application's GUI).

In an alternate embodiment, the software configuration management system 125 can utilize multiple repositories 135 distributing storage of the source code files 165. The use of multiple repositories 135 can be transparent to the developer 105, masked by the filesystem 160. Further, the multiple repositories 135 can be distributed among multiple servers (not shown) that are accessible to the software configuration management system 125 over the network 170.

Because typical filesystems 160 only support the parent-child relationships between container objects and other container objects or source code files 165, the reuse of source code files 165 between multiple software applications and/or application revisions can require the developer 105 to manually copy the desired source code files 165 between folders. This manual process can be fraught with errors due to miss-clicked files 165 and/or selection preferences (i.e., only copying a subset of files from a folder).

For example, two groups of developers 105 working in parallel on separate versions of the same software application must continually copy common source code files 165 back and forth between their projects. Even with the safeguards of the software configuration management system 125, a developer 105 can still mistakenly copy over the wrong revision or copy a file 165 from the wrong location.

To automate the propagation of copies of a changed source code file 165, the software configuration management system 125 can be configured to support the use of the change flow manager 130 and stream-based change flow models 150. The change flow manager 130 can represent a software component configured to handle the identification and propagation of new or newer revisions of source code files 165 within the filesystem 160 of the software configuration management system 125. In one embodiment, propagation of changes performed by the change flow manager 130 can require approval of a developer 105 associated with the stream-based change flow model 150. That is, process controls (including approval steps or other team based configurable criteria) can be implemented for system 100. In one embodiment, flows can also be automated, in which case developer 105 interventions may not be necessary.

The stream-based change flow models 150 can provide the means by which a developer 105 can define which source code files 165 should be copied where. To support the stream-based change flow models 150, the software configuration management system 125 can be configured to allow the creation and storage of streams 140 and components 145.

A component 145 can be an object stored within the repository 135 that represents a low-level logical grouping of source code files 165 such as the GUI folder of the previous example. Components 145 can be automatically generated by the change flow manager 130 by parsing the filesystem 160. A stream 140 can be a logical aggregate of components 145, such as a software version or project. As shown by the example 152, streams 140 and components 145 can associated using change flow relationships 154 to graphically illustrate how changes within the software configuration management system 125 should propagate.

A change flow relationship 154 can be a graphical association between a stream 140 or component 145 and another stream 140 or component 145 (e.g., stream-to-stream, component-to-component, or component-to-stream). The change flow relationship 154 can also represent the directionality (i.e., an arrowhead) in which changes in the streams 140 or component 145 should flow.

In addition to the graphical portion, model data 156 can be captured as part of the stream-based change flow model 150. The model data 156 can represent key items of information that can affect how changes propagate. As shown in example 152, model data 156 can include information about overrides (i.e., component-level versus stream-level), the location of the components 145 within the software configuration management system 125 and/or filesystem 160, a manifest of all components 145, and a responsible developer 105.

The streams 140 and stream-based change flow models 150 can be visually defined using the change flow interface 120 within the software configuration management user interface 115. The change flow interface 120 can represent an interaction mechanism that allows the developer 105 to perform operations related to the streams 140 and stream-based change flow models 150, such as create, edit, and compare. Operations performed within the change flow interface 120 can be conveyed by the software configuration management user interface 115 over the network 170 to the software configuration management system 125 and change flow manager 130.

The software configuration management user interface 115 can represent a graphical interaction mechanism by which the developer 105 can perform the various operations and/or view the data of the software configuration management system 125. The software configuration management user interface 115 can be configured to operate upon a client device 110, per the operating requirements of the software configuration management system 125, and can be configured to support operation of the change flow interface 120.

In another contemplated embodiment, the change flow manager 130 and stream-based change flow models 150 can be extended to work within the context of a software configuration management system 125 that utilizes change flow hierarchies to synchronize source code files 165, such as described in U.S. Published Application No. 2008/0120591, entitled “COMPUTER METHOD AND APPARATUS FOR MANAGING SOFTWARE CONFIGURATIONS USING CHANGE FLOW HIERARCHIES” which is herein incorporated by reference for showing one contemplated embodiment of the disclosure. In such an embodiment, the change flow manager 130 can be invoked after synchronization to propagate the synchronized file within the filesystem 160. Additionally, the stream-based change flow models 150 can be modified to accommodate the use of workspaces.

Network 170 can include any hardware/software/and firmware necessary to convey data encoded within carrier waves. Data can be contained within analog or digital signals and conveyed though data or voice channels. Network 170 can include local components and data pathways necessary for communications to be exchanged among computing device components and between integrated device components and peripheral devices. Network 170 can also include network equipment, such as routers, data lines, hubs, and intermediary servers which together form a data network, such as the Internet. Network 170 can also include circuit-based communication components and mobile communication components, such as telephony switches, modems, cellular communication towers, and the like. Network 170 can include line based and/or wireless communication pathways.

As used herein, presented repository 135 can be a physical or virtual storage space configured to store digital information. Repository 135 can be physically implemented within any type of hardware including, but not limited to, a magnetic disk, an optical disk, a semiconductor memory, a digitally encoded plastic memory, a holographic memory, or any other recording medium. Repository 135 can be a stand-alone storage unit as well as a storage unit formed from a plurality of physical devices. Additionally, information can be stored within repository 135 in a variety of manners. For example, information can be stored within a database structure or can be stored within one or more files of a file storage system, where each file may or may not be indexed for information searching purposes. Further, repository 135 can utilize one or more encryption mechanisms to protect stored information from unauthorized access.

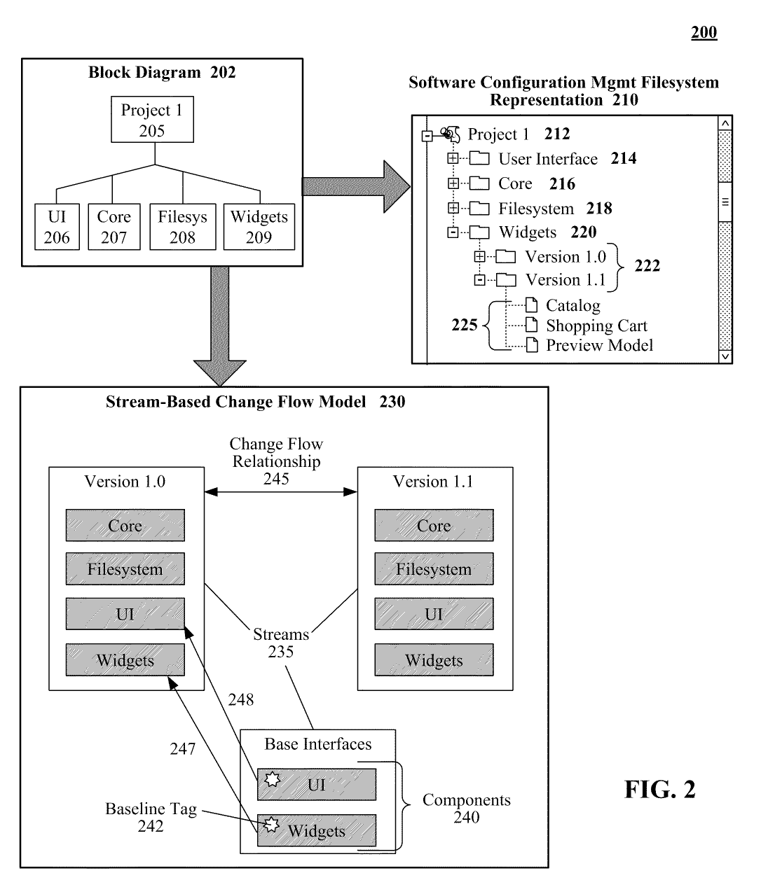

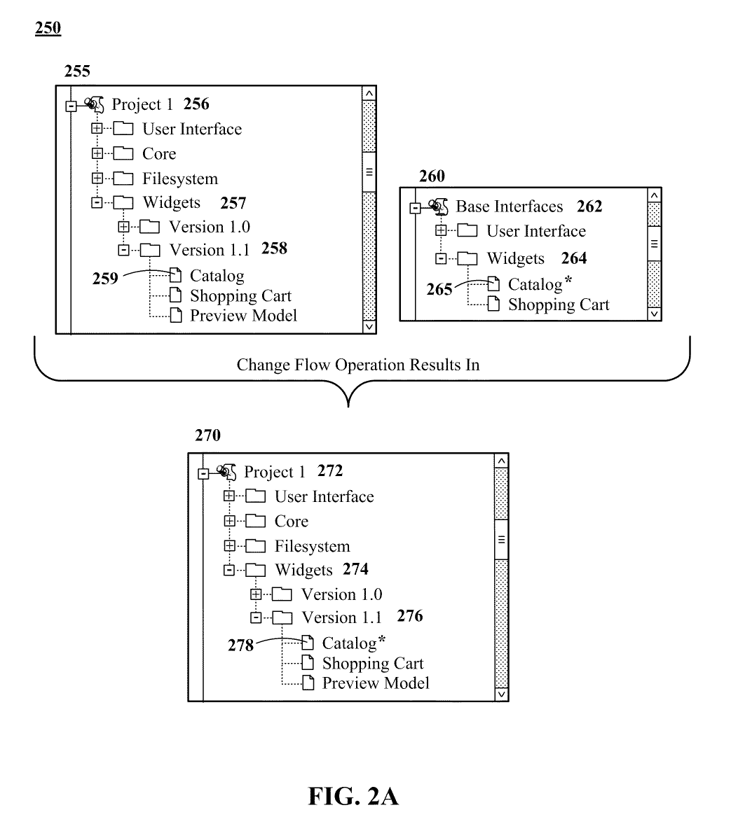

FIG. 2 is a collection 200 of example representations 202, 210, and 230 of a software application project in accordance with embodiments of the inventive arrangements disclosed herein. The example representations 202, 210, and 230 of collection 200 can be utilized within the context of system 100. Collection 200 can include a block diagram 202, a software configuration management filesystem representation 210, and a stream-based change flow model 230 of the same example software application.

A block diagram 202 can be used to describe the software application at a high level, focusing on function and not implementation. As shown by the block diagram 202, the example software application can be represented by the project 1 block 205. Blocks representing the subsystems of the software application can be connected to the project 1 block 205. In this example, project 1 205 can include a core subsystem 206, a user interface (UI) subsystem 207, a widgets subsystem 208, and a filesystem subsystem 209. The subsystems 206-209 can represent the main categories of functionality included in the software application.

Within a software configuration management system, block diagram 202 can have a more detailed filesystem representation 210. The software configuration management filesystem representation 210 can illustrate the hierarchical tree structure used in many software configuration management systems to logically organize software projects 212, their components 214-220, and associated source code files 225.

In the software configuration management filesystem representation 210, the software application can be represented by a project object 212, similar to the project 1 block 205 of the block diagram 202. Each subsystem 206-209 of the block diagram 202 can be represented by a corresponding folder object 214-220.

Unlike the block diagram 202, the software configuration management filesystem representation 210 can also include information pertinent to implementation, such as the branching represented by the version folders 222 of the widgets folder 220. While branching is useful for visualizing and logically grouping differences, these subgroupings can require additional file management by developers to ensure that dependencies between versions 222 and/or projects 212 are manually maintained.

The stream-based change flow model 230 for the software application can visually express the flow of changes between logical groupings. Thus, the dependencies between projects 212, versions 222, and components 214-220 can be captured in a persistent document that can be utilized by the change flow manager to automate the propagation of changed source code files within the software configuration management system. The current manual process can be eliminated as well as improved by increasing the visibility of code reuse and documentation of dependencies.

As previously discussed, the stream-based change flow model 230 can include multiple streams 235, each containing components 240 defined within the software configuration management system. A stream 235 or component 240 can be associated to another stream 235 or component 240 by a change flow relationship 245, 247, or 248.

In this example, the stream-based change flow model 230 represents the flow of changes for the software application from the version 1.0 stream 235 to the version 1.1 stream 235. Change flow relationship 245 can indicate that all changes that occur in the version 1.0 stream 235 should propagate to the version 1.1 stream 235 and vice versa.

A change to the UI component 240 of the base interfaces stream 235 can propagate to the UI component 240 of the version 1.0 stream 235 via change flow relationship 248, and, subsequently to the version 1.1 stream 235 via change flow relationship 245. A similar propagation chain can be defined for the widgets component 240 via change flow relationship 247.

It is important to recognize that propagation of source code file from one stream/component to another does not mean a total overwrite of the stream/component. That is, the widgets component of the version 1.0 stream 235 can include source code files that are additional to and are unaffected by those contained in the widgets component of the base interfaces stream 235. For example, if the widgets component of the version 1.0 stream 235 contains files A, B, and G and the widgets component of the base interfaces stream 235 contains files B and G, file A can remain unaffected by any changes to files B or G propagated from the base interfaces stream 235.

It should also be noted that both the UI and widgets components 240 of the version 1.0 stream 235 have two sources of changes, at the stream-level via change flow relationship 245 and at the component-level via change flow relationships 247 and 248. Resolution of a potential conflict can be handled utilizing the user-defined model data, such as the model data 156 of system 100, which can be captured for a stream-based change flow model 230.

To further facilitate the software development process, a component 240 can include a user-selected baseline tag 242. The baseline tag 242 can be used to indicate that the corresponding component 240 is considered a primary element of the software application. The baseline tag 242 can be utilized by the change flow interface to provide additional information and operations to the developer. For example, the developer can have a report generated that details the components 240 having baseline tags 242 and their change flow relationships.

It should be noted that while conventional software configuration management systems provide the ability to identify folders and/or source code files as “baseline”, these systems are unable to provide relationship information about these baseline elements. That is, a conventional software configuration management system can tell a developer which items are considered to be baseline, but cannot tell them how those items relate to other items.

An example scenario 250, illustrated in FIG. 2A and expanding upon the example representations 210 and 230 of collection 200, can illustrate the benefit of this embodiment of the present invention. The example scenario 250 can include multiple software configuration management filesystem representations 255 and 260 available to the developer within the software configuration management system and the resultant view 270 once the stream-based change flow model 230 is performed.

In this example, filesystem representation 260 can illustrate that a new version of the catalog 265 source file (indicated by the asterisks) has been submitted to the widgets folder 264. The widgets folder 264 to which the catalog file 265 is added can belong to a project object 262 named “Base Interfaces”.

It should be noted that the name of the project 262 need not be the same as the name of the stream 235 used in the stream-based change flow model 230, as shown in example scenario 250. Since the stream-based change flow model 230 can store the path locations for components 240, the path hierarchy of the widgets folder 264 and not the name of the parent project 262 can be the identification utilized by the change flow manager.

Filesystem representation 255 can be a reiteration of the software configuration management filesystem representation 210 of collection 200, acting as a snapshot of the existing catalog file 259 stored within the version 1.1 folder 258 of the widgets folder 257 of project 1 256 prior to the change propagation.

In a conventional software configuration management system, a developer working on project 1 256 would have to be informed of the new version and find the new version of the catalog file 265, as in filesystem representation 260. Using the software configuration management user interface, the developer would then copy the catalog 265 source code file to desired destination folder, such as the version 1.1 folder 258.

Depending on work distribution and the communication of code dependencies for the development of project 1 256, manual propagation of changes to source code files can incur unexpected problems. For example, a developer working on version 1.1 can copy the new catalog file 265 to only the version 1.1 folder 258, leaving the version 1.0 folder with an older version. If developers working on version 1.0 do not perform the same manual copy process, a divergence in coding can result that can require merging multiple files at a later time, which is typically a manual process but can also be an automated one in accordance with the teachings provided herein.

For example, in a software configuration management system utilizing the stream-based change flow model 230, the change flow manager could automatically notify the developers associated with the stream-based change flow model 230 and request approval to propagate the new revision of the catalog file 265. Upon receiving approval, the change flow manager can follow the change flow relationships 245 and 247 and perform the necessary copy operations, resulting in filesystem representation 270. In another example, the same changes can flow to another stream, which has more lenient controls and that permits the flowing of changes as an automated process not requiring explicit developer approval responses.

While file system representation 270 does not look much different than filesystem representation 255, the main point is that the new catalog file 278 has been automatically copied into the version 1.1 folder 276 of the widgets folder 274 for project 1 272. Further, according to stream-based change flow model 230, the new catalog file 278 would also now exist within the version 1.0 folder as well as other folders that correspond to components having a change flow relationship indicating the receipt of changes for the widgets folder 264 of filesystem representation 260.

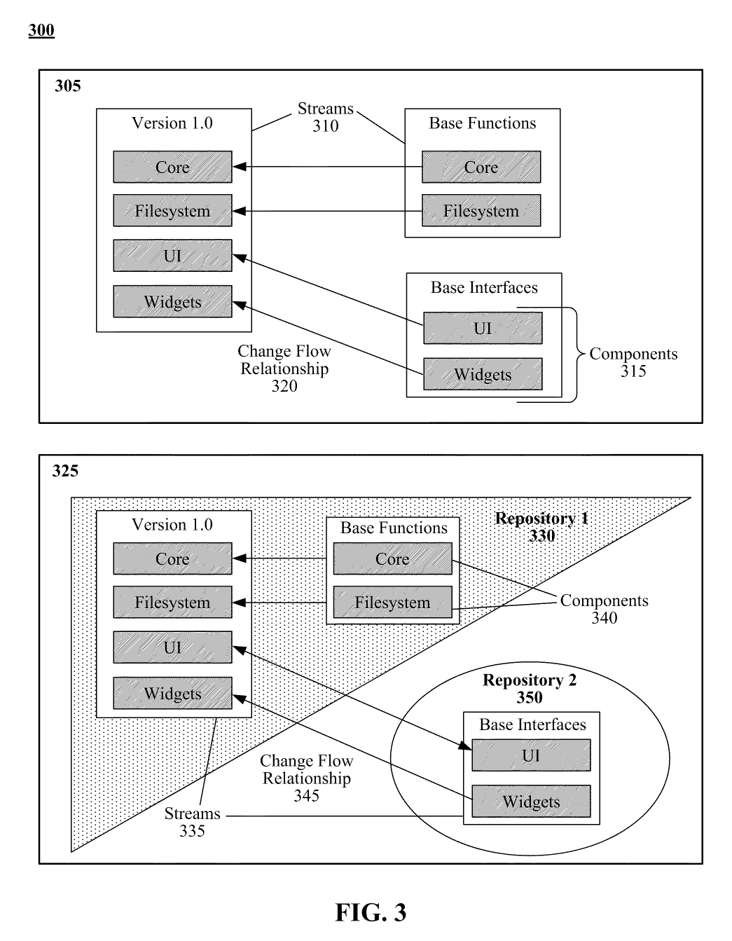

FIG. 3 is a collection 300 of additional example stream-based change flow models 305 and 325 in accordance with embodiments of the inventive arrangements disclosed herein. The example stream-based change flow models 305 and 325 of collection 300 can be utilized within the context of system 100.

Example stream-based change flow model 305 can illustrate a model in which the change flow relationships 320 are defined at only between components 315. That is, example stream-based change flow model 305 does not include a change flow relationship 320 that exists between two streams 310.

While expression of the change flow relationships 320 at this level may appear to be unnecessary, it can have impact when the same stream 310 is used in multiple stream-based change flow models when determining the precedence of a change. For example, a component-level change flow relationship 320 can be given priority over a stream-level relationship, as specified within the model data for the stream-based change flow model.

Example stream-based change flow model 325 can illustrate a model whose streams 335 and/or components 340 span multiple repositories 330 and 350. In this example 325, the component 340 for the version 1.0 and base functions streams 335 can be stored in repository 1 330, whereas repository 2 350 can contain the data for the base interfaces stream 335.

The difference in repository location can be graphically presented within the change flow interface, such as the color/shape differences between repository 1 330 and repository 2 350 in this example 325. The change flow relationships 345 of the stream-based change flow model 325 can be arranged to visually span the grouped streams 335.

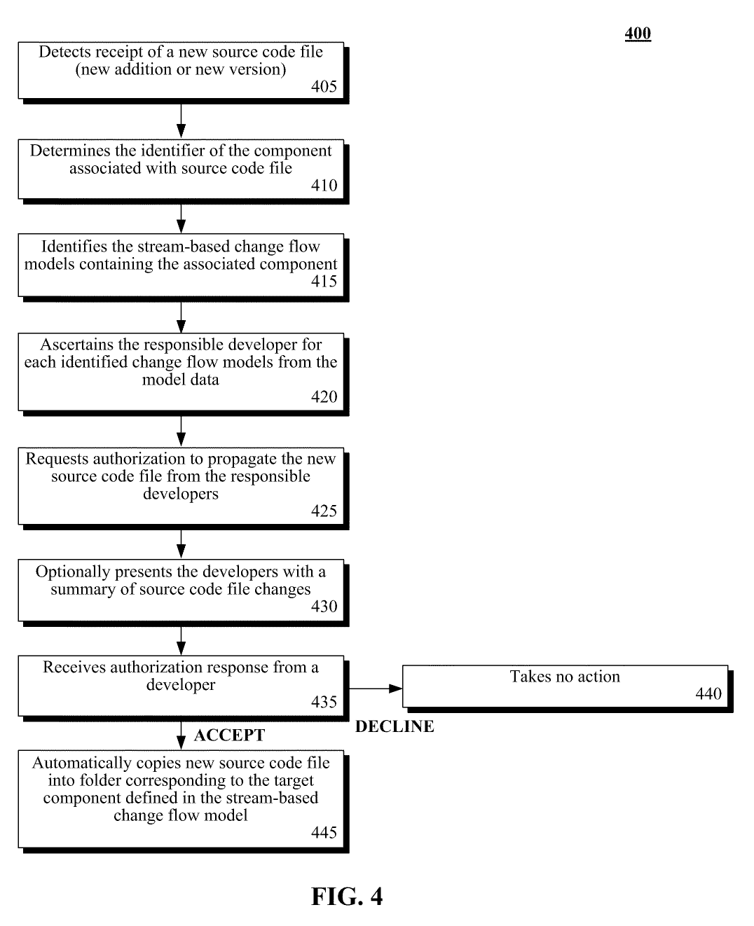

FIG. 4 is a flow chart of a method 400 detailing the automated propagation of new source code files using a stream-based change flow model in accordance with embodiments of the inventive arrangements disclosed herein. Method 400 can be performed within the context of system 100 or any other system supporting the use of stream-based change flow models to propagate changes within a software configuration management system.

Method 400 can begin in step 405 where the change flow manager can detect the receipt of a new source code file. The new source code file can correspond to the addition of a file previously not contained within the software configuration management system or a new version of an existing file. The identifier of the component associated with the source code file can be determined in step 410.

In step 415, the change flow manager can identify the stream-based change flow models that contain the component associated with the source code file. From the model data, the responsible developers can be ascertained in step 420.

In step 425, authorization to propagate the new source code file can be requested from the responsible developers. Step 425 can utilize a variety of means available within the software configuration management system and/or parent network. For example, the change flow manager can send an email form to the developers or can deny access to the source code files that have a change authorization pending.

Optionally, a summary of the source code file changes can be presented to the developers in step 430. Performance of step 430 can depend upon the implementation used to perform step 425. For example, the summary of changes can be included within an email message.

In step 435, an authorization response can be received. When the developer declines to give authorization, the change flow manager can perform step 440, taking no action. Method 400 can be expanded at this branch to include additional logging of authorization responses for historical purposes.

When the developer accepts authorization, the new source code file can be automatically copied into the folder that corresponds to component defined as the target of the change flow within the stream-based change flow model in step 445.

It should be appreciated that it can be a change set that flows among nodes in process 400 and throughout the disclosure. That is, the actual source code file does not necessarily need to be copied in step 445, only the relevant change set. This change set can describe the changes to be made to files and folders. The result of applying the change set can be that the appropriate files and folder structures are created (from the change set). Therefore, the end result is that the new source code file is “copied” into a folder, even though no actual copying needs to take place (i.e., instead, a change set is applied to alter the destination folder so that it contains desired content).

It should be noted that need for developer authorization can be omitted from method 400, eliminating steps 420-440. For example, in one contemplated embodiment, flowing as detailed herein can be governed by the process applied to the destination of changes. That is, changes delivered to one destination can be in accordance with a first set of conditions, changes delivered to another destination can be in accordance with a second set of conditions, etc. Thus, delivery to one destination (in accordance with the first set of conditions) may require developer approvals, where delivery to another destination (in accordance with the second set of conditions) may not require developer approvals.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. An automated method for using stream-based change flow models to propagate source code file changes within a software configuration management system comprising:
detecting of an addition of a source code file to a software configuration management system by a change flow manager, wherein said addition comprises at least one of the addition of a new source code file and the addition of a new version of an existing source code file;
relating said source code file to a component based upon a hierarchical placement of the source code file within a filesystem of the software configuration management system, wherein an identifier of said component corresponds to an identifier of a container object within the filesystem, wherein said container object denotes a primary subsystem of a software application;
identifying at least one stream-based change flow model containing the component, wherein the at least one stream-based change flow model defines at least one change flow relationship between a first stream having the component as a constituent and at least one of a second stream and a second component of the second stream, wherein the at least one of the second stream and the second component of the second stream is designated as a recipient for changes of the component, wherein a stream is an abstract representation for an aggregate of components; and
automatically copying the source code file into at least one container object of the filesystem that corresponds to the identified recipient for changes defined within the at least one stream-based change flow model.

2. The method of claim 1, wherein said addition is an addition of the new source code file.

3. The method of claim 1, wherein said addition is an addition of the new version of the existing source code file.

4. The method of claim 1, further comprising:
requesting authorization from a human agent to propagate the source code file within the software configuration management system according to the at least one stream-based change flow model, wherein the automatically copying of the source code file occurs responsive to a receipt of an affirmative response to the authorization request.

5. The method of claim 3, wherein the at least one stream-based change flow model comprises a plurality of model data comprising at least an identifier of the human agent and at least one of an override precedence, a listing of components, and a listing of component locations within the filesystem.

6. The method of claim 5, wherein the request for authorization further comprises:
determining the identifier of the human agent from the plurality of model data associated with the at least one stream-based change flow model;
generating a notification message; and
conveying the notification to the human agent.

7. The method of claim 4, wherein the request for authorization further comprises:
optionally, presenting a summary of changes proposed by the source code file to the human agent.

8. The method of claim 4, wherein the request for authorization utilizes an electronic communications system external to the software configuration management system.

9. The method of claim 1, wherein, when the new version of the existing source code file is detected, the request for authorization further comprises:
determining at least one occurrence of the source code file within the filesystem; and
locking the at least one occurrence of the source code file, wherein said lock is released upon receipt of a response to the request for authorization.

10. The method of claim 4, further comprising:
upon receipt of a negative response to the authorization request, recording data regarding the negative response to propagating the source code file within a predefined document.

11. A software configuration management system that utilizes stream-based change flow models to automate the propagation of source code file changes comprising:
a plurality of components corresponding to container objects of at least one source code file within a filesystem of a software configuration management system, wherein said container objects correspond to primary subsystems of software applications stored within the software configuration management system;
a plurality of streams abstractly defining aggregates of components;
a plurality of stream-based change flow models defining at least one change flow relationship between at least one of a first stream and a component of the first stream and at least one of a second stream and a second component of the second stream, wherein the at least one of the second stream and the second component of the second stream is designated as a recipient for changes of the component;
a change flow interface configured to provide a graphical interaction mechanism for capturing, presenting, and performing operations upon the plurality of stream-based change flow models; and
a change flow manager configured to automate propagation of changes to a source code file within the software configuration management system based upon change flow relationships of the plurality of stream-based change flow models, wherein said propagation requires authorization from a human agent.

12. The software configuration management system of claim 11, wherein the change flow interface is an element of a graphical user interface (GUI) of the software configuration management system.

13. The software configuration management system of claim 11, wherein a stream-based change flow model further comprises:
a plurality of model data comprising at least an identifier of the human agent and at least one of an override precedence, a listing of components, and a listing of component locations within the filesystem.

14. The software configuration management system of claim 13, wherein the identifier of the human agent is utilized by the change flow manager to request authorization to propagate changes within the software configuration management system.

15. A computer program product comprising a computer readable storage medium having computer usable program code embodied therewith, the computer usable program code comprising:
computer usable program code configured to detect an addition of a source code file to a software configuration management system, wherein said addition comprises at least one of the addition of a new source code file and the addition of a new version of an existing source code file;
computer usable program code configured to relate said source code file to a component based upon a hierarchical placement of the source code file within a filesystem of the software configuration management system, wherein an identifier of said component corresponds to an identifier of a container object within the filesystem, wherein said container object denotes a primary subsystem of a software application;
computer usable program code configured to identify at least one stream-based change flow model containing the component, wherein the at least one stream-based change flow model defines at least one change flow relationship between a first stream having the component as a constituent and at least one of a second stream and a second component of the second stream, wherein the at least one of the second stream and the second component of the second stream is designated as a recipient for changes of the component, wherein a stream is an abstract representation for an aggregate of components;
computer usable program code configured to request authorization from a human agent to propagate the source code file within the software configuration management system according to the at least one stream-based change flow model; and
computer usable program code configured to, upon receipt of an affirmative response, automatically copy the source code file into at least one container object of the filesystem that corresponds to the identified recipient for changes defined within the at least one stream-based change flow model.

16. The computer program product of claim 15, wherein the at least one stream-based change flow model comprises a plurality of model data comprising at least an identifier of the human agent and at least one of an override precedence, a listing of components, and a listing of component locations within the filesystem.

17. The computer program product of claim 16, wherein the request for authorization further comprises:
computer usable program code configured to determine the identifier of the human agent from the plurality of model data associated with the at least one stream-based change flow model;
computer usable program code configured to generate a notification message; and
computer usable program code configured to convey the notification to the human agent.

18. The computer program product of claim 15, wherein the request for authorization further comprises:
computer usable program code configured to present a summary of changes proposed by the source code file to the human agent.

19. The computer program product of claim 15, wherein, when the new version of the existing source code file is detected, the request for authorization further comprises:
computer usable program code configured to determine at least one occurrence of the source code file within the filesystem; and
computer usable program code configured to lock the at least one occurrence of the source code file, wherein said lock is released upon receipt of a response to the request for authorization.
